(19) United States
(12) Patent Application Publication
(10) Pub. No.: US 2010/0162522 A1
(43) Pub. Date: Jul. 1, 2010

(54) DAMPER DEVICE

(75) Inventors: Munsu Han, Kanagawa (JP); Sunghyun Byun, Aichi (JP); Takahiro Sakai, Lancashire (GB)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: PIOLAX INC., Yokohama-shi, Kanagawa (JP)

(21) Appl. No.: 12/733,409

(22) PCT Filed: Jul. 8, 2008
(86) PCT No.: PCT/JP2008/062307

§ 371 Date: Feb. 26, 2010

(30) Foreign Application Priority Data
Aug. 31, 2007 (JP) 2007-226498

(51) Int. Cl. E05F 3/18

(52) U.S. Cl. 16/67; 16/70

(57) ABSTRACT

It is an object of the present invention to provide a damper device which can facilitate an operation to incorporate it into a storage device including an openable/closable member.

The damper device includes a cylindrical-shaped cylinder 10, a piston 20 reciprocatingly movable within the cylinder 10 in the axial direction, a piston rod 30 having one end connected to the piston 20 with the other end exposed from the cylinder 10, and a spring 40 for energizing the piston rod 30 in a direction to push it into the inside of the cylinder 10. The damper device further includes hold means which, against the energizing force of the spring 40, can hold a piston 20 connecting member at a moved position where it has been pulled out from the cylinder 10. The hold means includes, for example, a secured pawl 31 provided on the piston rod 30 and an engaging hole 55 formed in a cap 50.

### TECHNICAL FIELD

The present invention relates to a damper device which is mounted on a storage device including an openable/closable member, for example, a glove box used in a vehicle for damping the opening operation of the openable/closable member.

### BACKGROUND ART

Conventionally, as a damper device of this type, there is known the device disclosed in the patent reference 1. The damper device (air damper) according to the patent reference 1 includes a cylindrical-shaped cylinder, a piston movable within the cylinder while keeping a sealed state, and a piston rod disposed continuously with the piston and movable out of and into one end of the cylinder. On the other end of the cylinder, there is mounted a cap which constitutes a valve mechanism. When the piston rod is moved in a pull-out direction from one end of the cylinder, the air existing outside flows bit by bit into the cylinder from an orifice formed in the cap to thereby generate a negative pressure, which applies a damping force to the piston rod. On the other hand, when the piston rod is moved in a direction where it is pushed into the inside of the cylinder, the valve mechanism formed in the cap is opened and the air existing within the cylinder is thereby discharged to the outside with no resistance, so that no damping force is applied to the piston rod.

This type of damper device, as shown in FIG. 21, is used to damp the opening-direction movements of an openable/closable box 102 or a lid (an openable/closable lid) of a glove box 101 which is incorporated into a front panel 100 of a vehicle.

Now, in the above-mentioned damper device according to the patent reference 1, the negative pressure, which is generated within the cylinder by the orifice formed in the cap, provides the damping force to the piston rod. However, when the lid or openable/closable box to be damped is a large-size part having a heavy weight, only the negative pressure generated by the orifice cannot provide a sufficient damping force. In view of this, like a damper device (an air damper) disclosed in the patent reference 2, there is also proposed a damper device which is structured such that, using the energizing force of a spring, a great damping force can be applied to a string-shaped member (which corresponds to the piston rod) in the pull-out direction thereof.

In the damper device (air damper) disclosed in the above patent reference 2, using the energizing force of the spring, a sufficient damping force can be applied to a piston connecting member (the above-mentioned string-shaped member or piston rod). On the other hand, the great energizing force from the spring also makes it difficult to mount the damper device onto the glove box.

That is, when mounting the damper device onto the glove box, not only the cylinder is mounted onto the main body of the glove box, but also, while keeping the lid or openable/closable box in an opened state, the piston connecting member is pulled out from the cylinder and the leading end portion thereof is connected to the side walls of the lid or openable/closable box. Here, the reason why the lid or opening closing member is kept in the opened state is that the side walls to be connected by the piston connecting member are to be exposed from the main body. In this manner, in order to connect the piston connecting member to the lid or openable/closable box in the opened state, the connecting member must be pulled out from the cylinder. At the then time, since the energizing force of the spring acts on the piston connecting member, an operator, while applying a force in a direction to pull out the piston connecting member, simultaneously must carry out an operation to connect the piston connecting member to the lid or openable/closable box, which results in the poor operation efficiency.
[Patent Reference 1] Japanese Patent Publication 2002-70910
[Patent Reference 2] U.S. Pat. No. 6,669,178

### DISCLOSURE OF THE INVENTION

### Problems that the Invention is to Solve

The present invention is made in consideration of such points. It is an object of the present invention to provide a damper device which can facilitate an operation to mount it onto a storage device including an openable/closable member.

### Means for Solving the Problems

In attaining the above object, according to the present invention, there is provided a damper device which comprises: a cylindrical-shaped cylinder; a piston reciprocatingly movable within the cylinder in the axial direction thereof; a piston connecting member having one end connected to the piston, at least the other end of the connecting member being exposed to the outside from the end face of the cylinder, and the piston connecting member being reciprocatingly movable together with the piston; and a spring for energizing the piston connecting member in a direction where it is pushed into the inside of the cylinder. And, the damper device is characterized in that hold means which, against the energizing force of the spring, can hold the piston connecting member at a movement position where it has been pulled out from the cylinder is provided.

The present invention having the above structure can provide the following notable operation effects when it is incorporated into a storage device including an openable/closable member in a state where the piston connecting member is pulled out from the cylinder.

That is, according to the present invention, the hold means, against the energizing force of the spring, can hold the piston connecting member at a movement position where it has been pulled from the cylinder. This can reduce the time and labor to pull out the piston connecting member, thereby being able to facilitate the operation to incorporate the damper device into the storage device.

The hold means includes a securing portion and a secured portion which is to be secured to the securing portion. One of the securing portion and the secured portion is composed of a pawl or a projecting portion, and the other can be composed of any one of a pawl, a projecting portion, a recessed portion and a hole to be secured to the pawl or projecting portion.

According to this structure, owing to the engagement between the pawl or projecting portion and any one of the pawl, projecting portion, recessed portion and hole, the pulled-out state of the piston connecting member can be held surely.

Also, according to the present invention, in the damper device in which the cylinder is mounted on a main body of a storage device including an openable/closable member, and the piston connecting member is connected to the openable/closable member, the hold means is structured such that it can hold the piston connecting member at a position where the piston connecting member has been pulled out beyond the range of such movement of the piston connecting member as caused by the opening and closing operation of the openable/closable member.

According to this structure, since the hold position of the piston connecting member for execution of the mounting operation into the storage device is set outside the moving range of the piston connecting member caused by the opening and closing operation of the openable/closable member, in a normal opening and closing operation, the piston connecting member is not held by the hold means, thereby being able to carry out the opening and closing operation smoothly.

Also, according to the present invention, there is provided a damper device in which the piston connecting member is composed of a rod-shaped piston rod, a cap is provided on the end portion of the cylinder and, in the cap, there is formed an opening through which the piston rod can be inserted. In this damper device, the hold means includes a securing portion formed in the cap and a secured portion which is formed in the piston rod and can be secured to the securing portion.

According to this structure, since the secured portion formed in the piston rod is engaged with the securing portion formed in the cap in a state where the piston rod (piston connecting member) is pulled out from the cylinder, the pulled-out state of the piston rod can be held against the energizing force of the spring.

Here, the secured portion includes a pair of secured portions respectively formed on the two symmetric side surfaces of the piston rod, and the securing portion is structured such that it can secure the pair of secured portions respectively at the opposing positions of the cap.

Normally, between the opening of the cap and piston rod, there is formed a clearance which allows the piston rod to slide therethrough. This clearance provides a cause to let the piston rod shake. However, owing to the above structure, the pair of secured portions, which are respectively formed on the two symmetric side surfaces of the piston rod, are secured to their associated securing portions of the cap that are opposed to them; and, therefore, in their secured portions, there exists no clearance any longer, thereby being able to prevent the shaking motion of the piston rod.

Also, there may also employed a structure in which, on the piston rod, there is provided a pawl or a projecting portion serving as the secured portion; on the cap, there is provided a wall portion expanding from the inside end face of the cap into the inside of the cylinder; and, in the wall portion, there is formed an engaging hole serving as the securing portion.

According to this structure, in the inside of the cylinder, the pawl or projecting portion is engaged with the engaging hole formed in the wall portion, which makes it possible to surely hold the pulled-out state of the piston rod.

Here, there can be employed a structure in which the pawl or projecting portion serving as the secured portion can be engaged the engaging hole serving as the securing portion from the inside of the wall portion and can be exposed to the outside of the engaging hole; a reinforcing rib is provided on and projected from the outer surface of the wall portion in such a manner that it extends through the edge portion of the engaging hole up to the inside end face of the cap; and, the spring is disposed on the outer periphery of the reinforcing rib.

According to this structure, the reinforcing rib provided on the outer surface of the cap wall portion can prevent the spring from touching the pawl or projecting portion exposed to the outside of the engaging hole, whereby the engaged state between the pawl or projecting portion and engaging hole can be held surely. Here, of course, the reinforcing rib can also increase the strength of the wall portion.

Also, according to the present invention, there can also be employed a structure in which, on the piston rod, there is provided a pawl or a projecting portion serving as the secured portion; on the cap, there is provided a wall portion expanding in the axial direction from the outside end face of the cap to the outside of the cylinder; and, in the wall portion, there is formed any one of a pawl, a projecting portion, a recessed portion and a hole serving as the securing portion.

According to this structure, outside the cylinder, the pawl or projecting portion can be engaged with the pawl, projecting portion, recessed portion or hole formed on the wall portion, thereby being able to surely hold the pulled-out state of the piston rod. Also, since the pawl, projecting portion, recessed portion or hole serving as the securing portion is formed in the wall portion which expands externally of the cylinder, even when the composing portion of the securing portion and/or the composing portion of the secured portion which is to be engaged with the securing portion is broken, the broken pieces thereof can be prevented from moving into the inside of the cylinder.

Here, the securing portion may include an elastic support piece which is cut out from the wall portion, and a securing piece provided on and projected from the inner surface of the support piece in such a manner that it is opposed to the piston.

According to this structure, the engaging pawl can secure the pawl or projecting portion of the piston rod using the elastic force of the support piece. Thus, simply by pushing in the piston rod, the support piece can be flexed elastically, thereby being able to easily release the secured state of the pawl or projecting portion provided by the securing pawl.

Further, the support piece may preferably be structured such that the axial-direction end portion thereof existing near to the cylinder is a free end cut out from the wall portion, whereas the axial-direction opposite side end portion thereof is a fixed end formed continuous with the wall portion.

According to this structure, when the piston rod is pushed into the cylinder in order to release the secured state of the pawl or projecting portion provided by the securing pawl, there is applied a force which can elastically flex the support piece outwardly in the diameter direction. Owing to this, the support piece is not buckled but is flexed properly to thereby release the secured state of the pawl or projecting portion by the secured pawl.

Also, preferably, in the wall portion, there may be formed a guide groove for sliding and guiding the piston rod in the axial direction, and the inside surface of the guide groove may be formed as a rotation preventer for preventing the piston rod from rotating about the center axis thereof.

According to this structure, since the guide groove is formed in the vicinity of the securing portion and the inside surface of the guide groove can prevent the piston rod from rotating about the center axis thereof, there can be eliminated the inconvenience that the secured state of the secured portion by the securing portion can be released unintentionally due to the rotation of the piston rod about the center shaft thereof.

Also, according to the present invention, in the damper device in which the piston connecting member is composed of a rod-shaped piston rod, the hold means may include a securing portion provided on the cylinder and a secured portion which is formed in the piston rod and can be secured to the securing portion.

According to this structure, since the secured portion formed in the piston rod is engaged with the securing portion formed in the cylinder in a state where the piston rod (piston connecting member) is pulled out from the cylinder, the pulled-out state of the piston rod can be held against the energizing force of the spring.

Further, according to the present invention, in the damper device in which, in the end portion of the cylinder, there is formed an opening through which the piston rod can be inserted, the secured portion may be composed of a pawl or a projecting portion provided on the piston rod, and the edge portion of the opening of the cylinder may constitute the securing portion.

According to this structure, when the pawl or projecting portion of the piston rod is engaged with the opening edge portion of the cylinder (securing portion), the pulled-out state of the piston connecting member can be held surely. Also, since the opening edge portion of the cap is used as the securing portion in this manner, the structure of the damper device can be simplified and thus the manufacture thereof can be facilitated.

Also, it is also possible to employ a structure in which, on the piston rod, there is provided a pawl or a projecting portion serving as the secured portion; on the cylinder, there is provided a wall portion expanding in the axial direction of the cylinder from the outside end face of the cylinder to the outside thereof; and, in the wall portion, there is formed any one of a pawl, a projecting portion, a recessed portion and a hole serving as the securing portion.

According to this structure, in the outside of the cylinder, the pawl or projecting portion is engaged with the pawl, projecting portion, recessed portion or hole formed in the wall portion, which makes it possible to surely hold the pulled-out state of the piston rod. And, since the pawl, projecting portion, recessed portion or hole serving as the securing portion is formed in the wall portion which expands externally of the cylinder, even when the composing portion of the securing portion and/or the composing portion of the secured portion which is to be engaged with the securing portion is broken, the broken pieces thereof can be prevented from moving into the inside of the cylinder.

Here, the securing portion may include an elastic support piece cut out from the wall portion and a securing pawl provided on and projected from the inner surface of the support piece in such a manner that it is opposed to the piston rod.

According to this structure, the engaging pawl can secure the pawl or projecting portion of the piston rod using the elastic force of the support piece. Therefore, simply by pushing the piston rod into the cylinder, the support piece can be elastically flexed, thereby being able to easily release the secured state of the pawl or projecting portion provided by the securing pawl.

Further, preferably, the axial-direction end portion of the support piece existing near to the cylinder may be formed as a free end cut out from the wall portion, whereas the opposite side axial-direction end portion thereof may be formed as a fixed end continuous with the wall portion.

According to this structure, when the piston rod is pushed into the cylinder in order to release the secured state of the pawl or projecting portion by the securing pawl, there is applied a force to elastically flex the support piece outwardly in the diameter direction. Owing to this, the support piece is not buckled d but can be properly flexed to thereby be able to release the secured state of the pawl or projecting portion provided by the securing pawl.

Also, preferably, in the wall portion, there may be formed a guide groove for sliding and guiding the piston rod in the axial direction, and the inside surface of the guide groove may be formed as a rotation preventer for preventing the piston rod from rotating about the center axis thereof.

According to this structure, since the guide groove is formed in the vicinity of the securing portion and the inside surface of the guide groove can prevent the piston rod from rotating about the center axis thereof, there can be eliminated the inconveniency that the secured state of the secured portion by the securing portion can be released unintentionally due to the rotation of the piston rod about the center axis thereof.

Also, according to the present invention, the damper device further includes a cap provided on the end portion of the cylinder and an opening formed in the cap for allowing the insertion of the piston connecting member therethrough. In this damper device, the hold means includes a securing portion formed in the cap and a secured portion which is formed in the piston and can be secured to the securing portion.

According to this structure, since the secured portion formed in the piston is engaged with the securing portion formed in the cap in a state where the piston connecting member is pulled out from the cylinder, the pulled-out state of the piston connecting member can be held against the energizing force of the spring.

Here, the hold means can include a securing portion formed in the cylinder and a secured portion which is formed in the piston and can be secured to the securing portion.

According to this structure, since the secured portion formed in the piston is engaged with the securing portion formed in the cylinder in a state where the piston connecting member is pulled out from the cylinder, the pulled-out state of the piston connecting member can be held against the energizing force of the spring.

Here, the piston connecting member can be made of a string-shaped member, the securing portion can be made of an engaging piece, and the secured portion can be made of a secured pawl which can be engaged with the engaging piece. Further, in the securing portion, there can be formed a releasing portion which is used to release the engaged state of the secured pawl.

According to this structure, owing to the engagement between the secured pawl and engaging piece, the pulled-out state of the string-shaped member (piston connecting member) can be held surely. Also, by operating the releasing portion, the engaged state can be released easily and thus the string-shaped member can be moved toward the inside of the cylinder.

### BRIEF DESCRIPTION OF THE DRAWINGS

FIG. 1 is a perspective view of a damper device according to a first embodiment of the present invention, showing the outer shape thereof.

FIG. 2A is an exploded perspective view of the damper device according to the first embodiment of the present invention. FIG. 2B is an enlarged view of the A portion shown in FIG. 2A. FIG. 2C is an enlarged view of the B portion shown in FIG. 2A.

FIG. 3A is a perspective view of the structures of a piston rod and a cap used in the damper device according to the first embodiment of the present invention. FIG. 3B is an enlarged view of the C portion shown in FIG. 3A.

FIG. 4 is a plan view of the damper device according to the first embodiment of the present invention, showing the outer shape thereof.

FIG. 5 is a partially cut-away front section view of the damper device according to the first embodiment of the present invention, showing a state where the piston rod is held at the pulled-out position thereof.

FIG. 6 is a partially cut-away front section view of the damper device according to the first embodiment of the present invention, showing a state where the piston rod is pushed into the damper device.

FIG. 7 is a partially cut-away front section view of the present invention, showing a state where the piston rod is pulled out from the damper device.

FIG. 8 is a section view to explain an operation to mount the damper device onto a glove box.

FIG. 9 is a section view to explain the operation of the damper device involved with the closing operation of the glove box.

FIG. 10 is a section view to explain the operation of the damper device involved with the opening operation of the glove box.

FIG. 11A is a partially cut-away section view of a damper device according to a second embodiment of the present invention. FIG. 11B is a plan view of the damper device according to the second embodiment of the present invention. FIG. 11C is a side view of the damper device according to the second embodiment of the present invention.

FIG. 12A is a front view of a piston rod according to the second embodiment of the present invention. FIG. 12B is a plan view of the piston rod according to the second embodiment of the present invention. FIG. 12C is a section view taken along the A-A line shown in FIG. 12A.

FIG. 13A is a partially sectional front view of a cap according to the second embodiment of the present invention, showing a state where the half section of the cap is cut away. FIG. 13B is a partially sectional plan view of the cap according to the second embodiment of the present invention, showing a state where the half section of the cap is cut away. FIG. 13C is a side view of the cap according to the second embodiment of the present invention.

FIG. 14A is a sectional plan view of the damper device according to the second embodiment of the present invention, showing a state where the piston rod is pushed into the cylinder. FIG. 14B is a sectional plan view of the damper device, showing a state where the piston rod is pulled out from the cylinder. FIG. 14C is an enlarged view of the D portion shown in FIG. 14B.

FIG. 15 is a front section view of a damper device according to a third embodiment of the present invention.

FIG. 16 is a front section view of a modification of the damper device according to the third embodiment of the present invention.

FIG. 17 is a front section view of a further modification of the damper device according to the third embodiment of the present invention.

FIG. 18 is a front section view of a damper device according to a fourth embodiment of the present invention.

FIG. 19 is a front section view of a modification of the damper device according to the fourth embodiment of the present invention.

FIGS. 20A to 20G are respectively section views of various structures of a securing portion and a secured portion.

FIG. 21 is a perspective view of the outline of a glove box incorporated into the front panel of a vehicle.

### DESCRIPTION OF REFERENCE NUMERALS AND SIGNS

10: Cylinder
11: Mounting hole
12: Engaging hole
13: Insertion hole
13a: Opening edge portion
14: Securing piece
14a: Base portion
15: Engaging wall
16: Support piece
16a: Securing pawl
20: Piston
21, 22: Flange
23: O ring
24: Air vent groove
25: Secured pawl
30: Piston rod
31: Secured pawl
32: Reinforcing rib
33: Mounting hole
34: Uneven portion
35: Secured rib
36: Reinforcing rib
37, 38: Rib
39: Projecting secured portion
40: Spring
50: Cap 51: Insertion hole
52: Fitting wall
53: Securing pawl
54: Engaging wall
55: Engaging hole
56: Reinforcing rib
57: Engaging hole
58: Support piece
58a: Securing pawl
59: Guide groove
60: Leading end cap
70: String-shaped member
80: Pawl
81: Pawl
82: Recessed portion
84: Hole
85: Projecting portion
101: Glove box
101a: Main body
102: Openable/closable box
103: Support shaft
110: Elongated groove
111: Stopper

### BEST MODE FOR CARRYING OUT THE INVENTION

Now, description will be given below in detail of embodiments of a damper device according to the present invention with reference to the accompanying drawings.

### First Embodiment

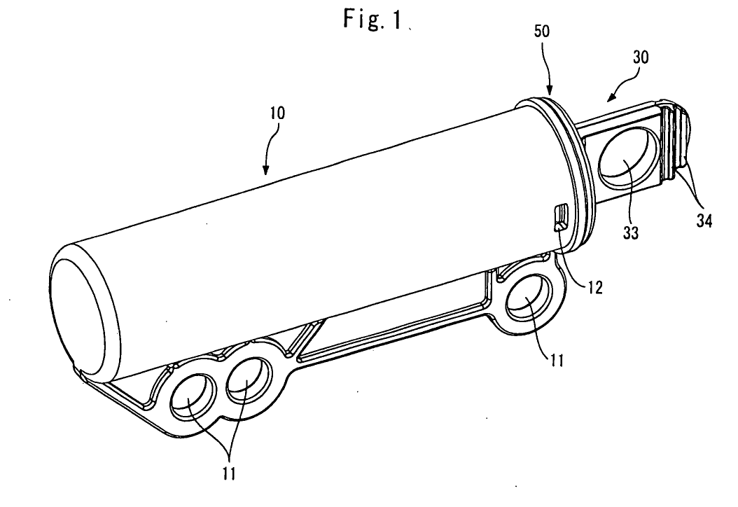

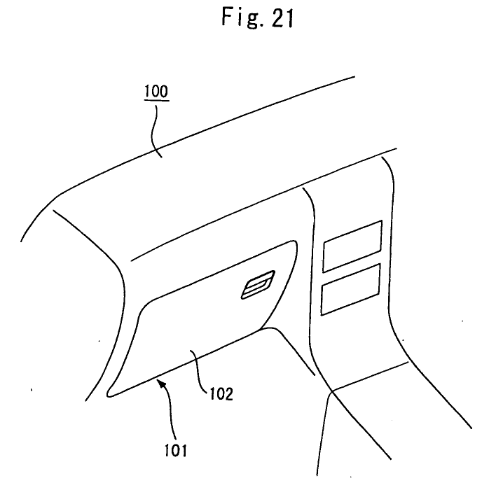

FIGS. 1 to 10 are respectively explanatory views of a damper device according to a first embodiment of the present invention. The damper device according to the present embodiment is incorporated into such a glove box 10 in a vehicle as shown in FIG. 21 and has a damping function to damp the movement of an openable/closable box 102 in the opening direction thereof.

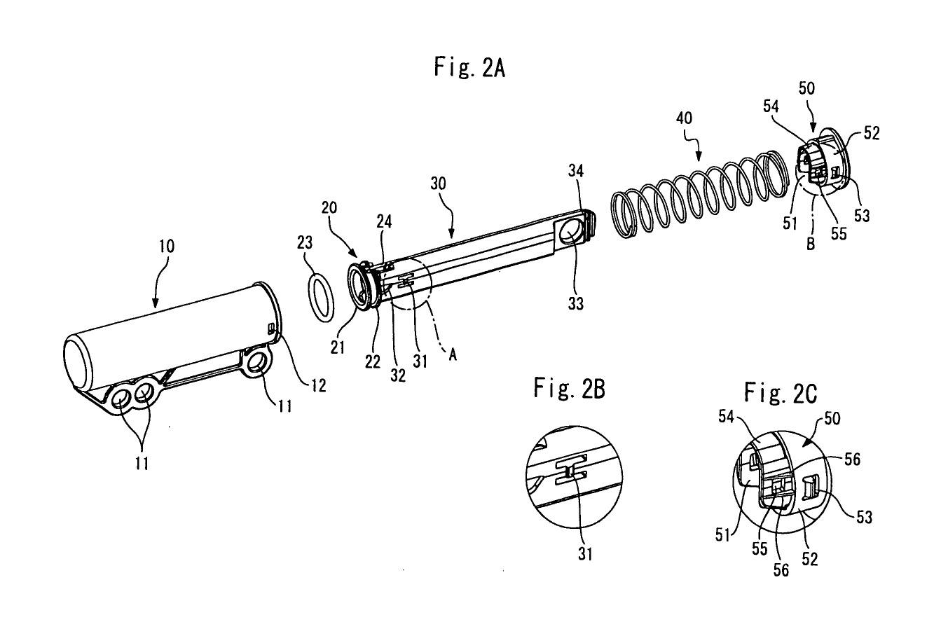

As shown in FIG. 2A, the damper device includes a cylinder 10, a piston 20, a piston rod 30, a spring 40 and a cap 50. Of these composing parts, the cylinder 10, piston 20, piston rod 30 and cap 50 are respectively resin moldings, while the spring 40 is a coil spring formed by working a steel-made wire member into a spiral-shaped member.

The cylinder 10 is formed to have a cylindrical shape with the leading end thereof closed, while, in the outer surface of the cylinder 10, there are formed mounting holes 11 which are used to mount the cylinder 10 onto a main body of the glove box 101 (see FIG. 1).

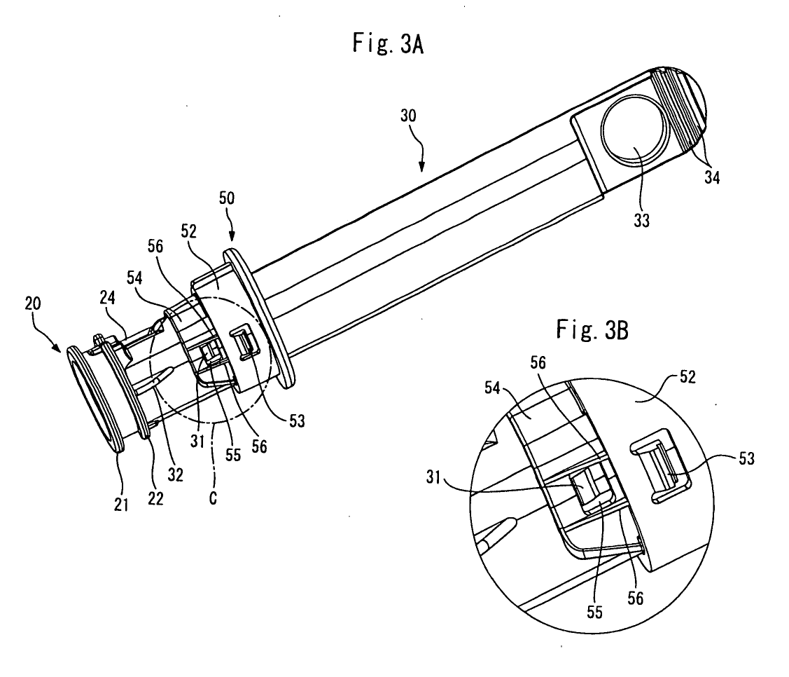

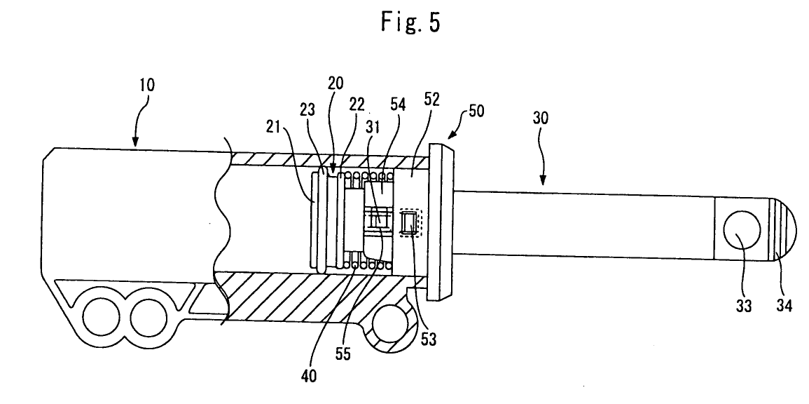

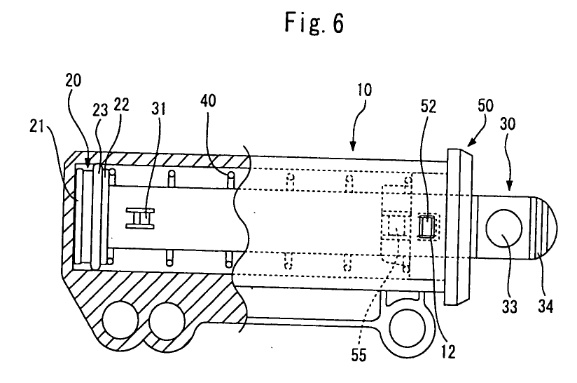

The piston 20 is provided on the leading end of the piston rod 30 integrally therewith. In other words, one end of the piston rod 30 is connected to the piston 20. On the leading and trailing end portions of the piston 20, there are provided flanges 21 and 22 which are projected in the outside diameter direction of the piston 20 and are spaced a given distance from each other as well as are arranged parallel to each other (see, for example, FIG. 3A). Into the middle portion of the piston 20 that is sandwiched by these flanges 21 and 22, there is fitted an O ring 23 (see, for example, FIG. 5). The O ring 23 is made of elastic synthetic rubber or the like and, in a state where the piston 20 is inserted within the cylinder 10, the O ring 23 is closely contacted with the inner wall of the piston rod 30. When the O ring 23 moves within the cylinder 10 in the axial direction of the cylinder 10, it is allowed to move in the axial direction with a friction force generated between the inner wall of the cylinder 10 and itself (see FIGS. 5 and 6). However, the moving range of the O ring 23 is limited to an area which is sandwiched by the two flanges 21 and 22.

Now, in the peripheral surface of the piston 20, there is formed an air vent groove 24 (see FIG. 3A) which can be formed by cutting out the flange 21 in such a manner that it extends to the peripheral surface of the piston rod 30. And, when the piston 20 moves within the cylinder 10 in the pull-out direction thereof (in FIG. 5, in the right direction), as shown in FIG. 5, the O ring 23 moves with respect to the piston 20 in the leading end direction of the piston 20 and is thereby contacted with the flange 21 that exists on the leading end side of the piston 20. In this state, since the O ring 23 is situated forwardly of the air vent groove 24 shown in FIG. 3A, the internal space of the cylinder 10 existing in front of the piston 20 is held airtight. Therefore, when an operator is going to move the piston rod 30 in the pull-out direction, the front internal space of the cylinder 10 becomes negative in pressure; and, this negative pressure acts on the piston rod 30 as a damping force, thereby damping the movement of the piston rod 30.

On the other hand, when the piston 20 moves within the cylinder 10 in the push-in direction thereof (in FIG. 6, in the left direction), as shown in FIG. 6, the O ring 23 moves with respect to the piston 20 in the trailing end direction of the piston 20 and is thereby contacted with the flange 21 that exists on the trailing end side of the piston 20. In this state, since the O ring 23 is situated in such a manner that it straddles the air vent groove 24 shown in FIG. 3A, the air in the internal space of the cylinder 10 existing in front of the piston 20, with the movement of the piston rod 30, flows through the air vent groove 24 into the rear internal space of the cylinder 10. Thus, no negative pressure can be applied to the piston rod 30, thereby allowing the piston rod 30 to move quickly.

In the damper device, the piston 20 is inserted from the trailing end opening of the cylinder 10 into the hollow portion of the cylinder 10 and the spring 40 is fitted with the outer surface of the outer periphery of the piston rod 30. After then, while pushing the spring 40 into the hollow portion of the cylinder 10, the cap 50 is mounted onto the trailing end opening of the cylinder 10. In the cap 50, as shown in FIGS. 2A and 2C, there is formed an insertion hole 51 for the piston rod 30, while the trailing end side of the piston rod 30 is exposed to the outside from the insertion hole 51. Here, in the vicinity of the trailing end portion of the cylinder 10, there is formed an engaging hole 12 for fixing the cap 50; and, on the cap 50, specifically, on the wall (fitting wall) 52 thereof that can be fitted with the inner wall of the cylinder 10, there is provided a securing pawl 53. That is, when the securing pawl 53 is engaged with the engaging hole 12, the cap 50 can be mounted onto the trailing end opening of the cylinder 10. The damper device can be assembled in this manner (see FIG. 1).

In the cap 50, as shown in FIGS. 2A and 2C, there is formed a thin engaging wall (wall portion) 54 in such a manner that it expands further from the fitting wall 52 to be fitted with the inner wall of the cylinder 10 in the internal direction of the cylinder 10; and, in the engaging wall 54, there is formed an engaging hole (a securing portion) 55. On the other hand, on the peripheral surface of the piston rod 30, as shown in FIGS. 2A and 2B, there is provided a secured pawl (a secured portion) 31. The piston rod 30 can be moved in the axial direction through the insertion hole 51 existing inside the engaging wall 54 and, when the piston 30 is pulled out in the pull-out direction (in FIG. 5, in the right direction), the secured pawl 31 is engaged with the engaging hole 55 from inside the engaging wall 54 (see FIGS. 3A, 3B and 5).

The piston rod 30 is energized by the spring 40 in a direction where it is pushed into the cylinder 10. One end of the spring 40 is contacted with the flange 22 of the piston 20 connected to the leading end of the piston rod 30, the other end of the spring 40 is contacted with a step portion formed between the fitting wall 52 and engaging wall 54 of the cap 50, and the spring 40 can be expanded and compressed between them as the piston rod 30 moves. And, in a state where the secured pawl 31 is engaged with the engaging hole 55, the piston rod 30 is held at the pull-out position thereof against the energizing force of the spring 40.

Here, when the engaging wall 54 is formed to have a small thickness, the leading end portion of the secured pawl 31 to be engaged with the securing hole 55 is exposed from the engaging hole 55 to the outside (see FIG. 3B). And, since, on the outer periphery of the engaging hole 55, there is provided the spring 40, when the spring 40 happens to shake in the diameter direction thereof, there is a fear that the spring 40 can be contacted with the secured pawl 31 exposed from the engaging hole 55 to thereby release the engagement of the secured pawl 31 with the securing hole 55.

In view of this, according to the present embodiment, on the outer surface of the engaging wall 54, there is provided a reinforcing rib 56 which extends through the edge portion of the engaging hole 55 to the inner end face of the cap 50 in such a manner that it projects in the outside diameter direction of the engaging wall 54 (see FIG. 3B). The spring 40 is disposed on the outer periphery of the reinforcing rib 56. According to this structure, not only the shaking motion of the spring 40 in the diameter direction thereof can be limited, but also the reinforcing rib 56 can prevent the spring 40 from touching the secured pawl 31 exposed from the engaging hole 55.

As shown in FIG. 3A, on the leading end portion of the piston rod 30, there is provided a reinforcing rib 32 which projects in the outside diameter direction of the piston rod 30 from the outer surface thereof in such a manner that it can be connected to the flanges 21 and 22 of the piston 20. The reinforcing rib 32 reinforces the flange 22 of the piston 20 and, at the same time, since one end of the spring 40 is situated on the outer periphery of the reinforcing rib 32, the movement of the spring 40 in the diameter direction can be prevented. This can prevent not only the generation of strange sounds and vibrations due to the shaking motion of the spring 40.

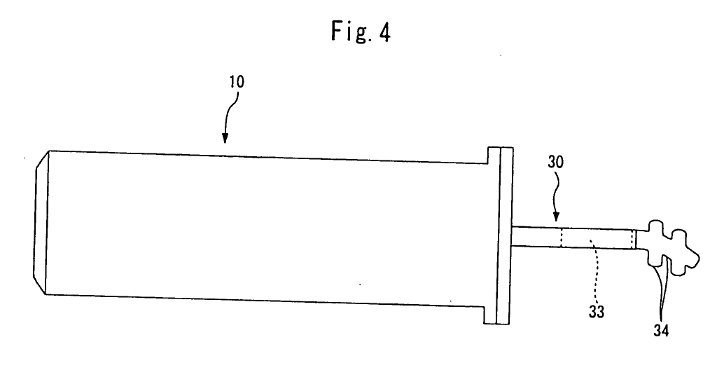

Also, as shown in FIG. 3A, in the trailing end portion of the piston rod 30, there is formed amounting hole 33 which is used to mount the piston rod 30 onto the openable/closable box 102 of the glove box 101. Also, on the rear end portion of the piston rod 30, there are provided a plurality of uneven portions 34 which are arranged side by side and respectively extend in a direction perpendicular to the center axis of the piston rod 30. These uneven portions 34 are provided in order that, when an operator pulls out the piston rod 30 from the cylinder 10, the operator can pinch the piston rod 30 easily and also the piston rod 30 can be made difficult to slip. Further, the trailing end portion of the piston rod 30, where the uneven portions 34 are provided, as shown in FIG. 4, is formed as a curved surface. The shape of this curved surface is devised in such a manner that the middle portion of the thumb or forefinger of the operator can fit it well, whereby the operator can pinch the piston rod 30 further easily and also the piston rod 30 can be made further difficult to slip.

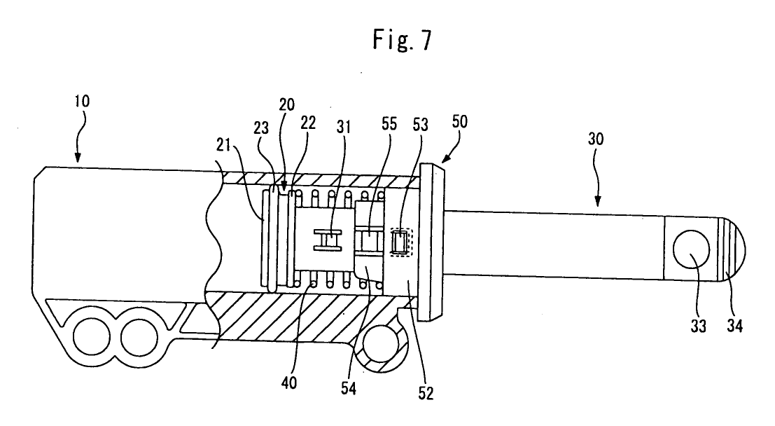

According to the above-structured damper device, as shown in FIG. 7, a position, just before the secured pawl 31 is engaged with the engaging hole 55, is determined as the terminal position of the pull-out movement in the opening and closing operation of the openable/closable box 102. Thus, as shown in FIG. 5, when the piston rod 30 is pulled out beyond this terminal position, the secured pawl 31 can be engaged with the engaging hole 55. Owing to this structure, when the openable/closable box 102 repeats its normal opening and closing operation, the secured pawl 31 can be prevented from being caught in the engaging hole 55 and, as a result of this, the opening and closing operation of the openable/closable box 102 can be carried out smoothly.

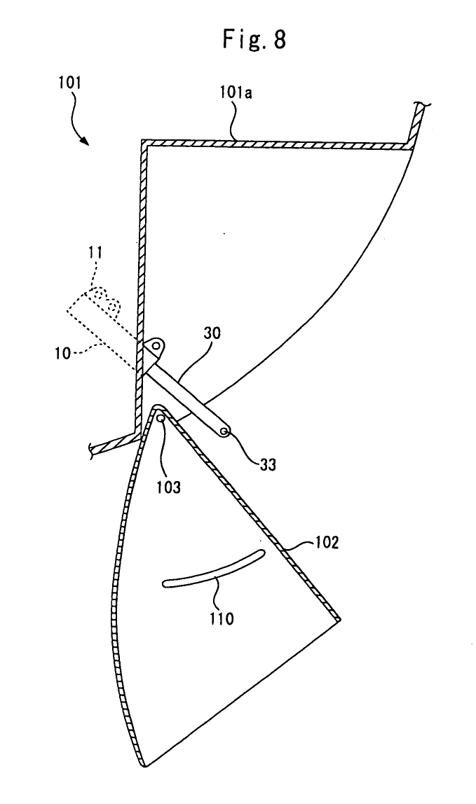

Next, description will be given below of the procedure and operation for mounting the damper device according to the present embodiment onto the glove box mainly with reference to FIGS. 8 to 10.

The glove box 101 is structured such that the openable/closable box 102 can be rotated about a support shaft 103 with respect to a main body 101a. In the damper device, the piston rod 30 is previously pulled out from the cylinder 10 and the secured pawl 31 is engaged with the securing hole 55 (see FIG. 5); and, in this state, the cylinder 10 is mounted onto the main body 101a of the glove box 101 (see FIG. 8).

Next, the glove box 101 is incorporated into the front panel of a vehicle and, after then, the trailing end portion of the piston rod 30 pulled out from the cylinder 10 is connected to the openable/closable box 102. At the then time, since the openable/closable box 102 is situated at the opened position and is exposed from the main body 101a of the glove box 101, the operation to connect the piston rod 30 can be executed easily. Also, since the piston rod 30 is held at the pulled-out position, there can be omitted the time and labor for an operator to pull out the piston rod 30 against the energizing force of the spring 40 and hold it at the pulled-out position, thereby being able to facilitate the connecting operation further.

After the trailing end portion of the piston rod 30 is connected to the openable/closable box 102, when the openable/closable box 102 is closed, the piston rod 30 of the damper device is pushed into the cylinder 10 and, at this time, the secured pawl 31 is released from the securing hole 55.

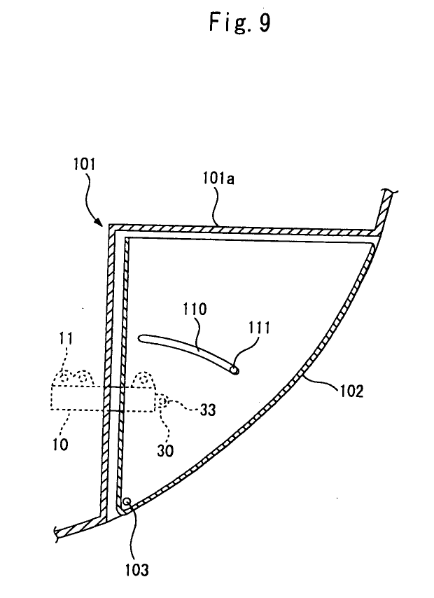

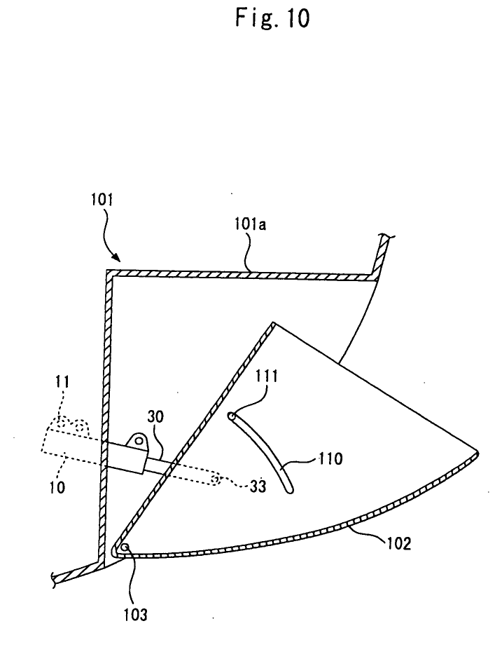

The openable/closable box 102 can be opened and closed, that is, it can be operated between a closed position shown in FIG. 9 and an opened position shown in FIG. 10. When the openable/closable box 102 is situated at the closed position shown in FIG. 9, according to the damper device, as shown in FIG. 6, the piston rod 30 is pushed into the cylinder 10. On the other hand, when the openable/closable box 102 is situated at the opened position shown in FIG. 10, according to the damper device, as shown in FIG. 7, the piston rod 30 is pulled out from the cylinder 10.

The opened position of the openable/closable box 102 is provided by full-open position regulating means. The full-open position regulating means may have various structures. Here, the full-open position regulating means shown in FIG. 10 is structured such that it includes an elongated groove 110 and a pin-shaped stopper 111 respectively formed in the side surface of the openable/closable box 102. The stopper 111 is fixed to the main body 101a and is inserted into the elongated groove 110. The elongated groove 110 is formed to have an arc-like shape with the support shaft 103 as the center of curvature. When the openable/closable box 102 is situated at the opened position, the stopper 111 is contacted with one end of the elongated groove 110 to thereby prevent the openable/closable box 102 from opening further.

When the openable/closable box 102 is opened from the state shown in FIG. 9 to the state shown in FIG. 10, not only the above-mentioned negative pressure generated within the cylinder 10 by the piston 20 but also the energizing force of the spring 40 are both applied to the piston rod 30 as damping forces, whereby the openable/closable box 102 is to be opened slowly.

Contrary to this, when closing the openable/closable box 102 from the state shown in FIG. 10 to the state shown in FIG. 9, as described above, no negative pressure is generated by the piston 20 but the spring 40 also acts in a direction to help the closing operation of the openable/closable box 102; and, therefore, even when goods are stored within the openable/closable box 102 and thus the weight of the openable/closable box 102 is heavy, the openable/closable box 102 can be closed smoothly with a small push-in force.

### Second Embodiment

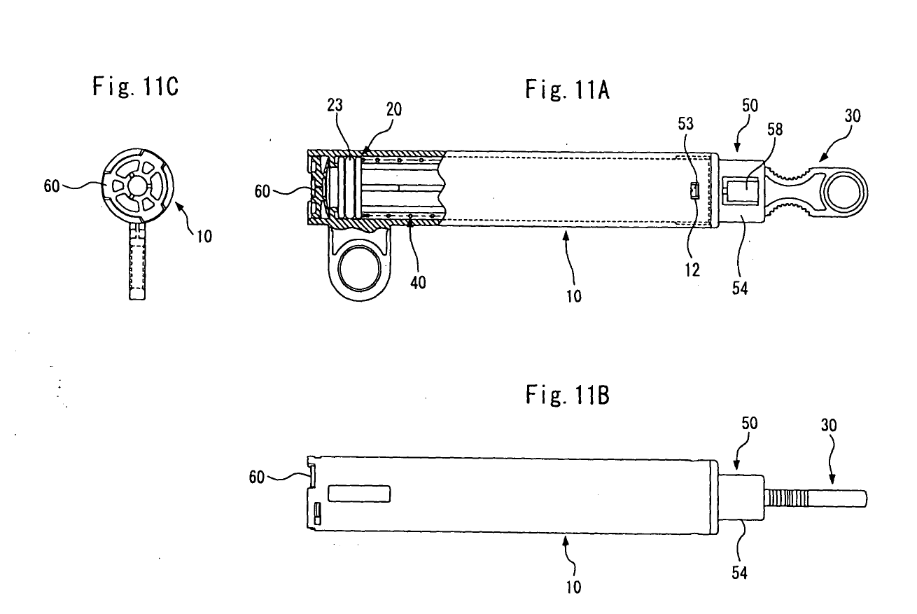

Now, FIGS. 11 to 14 are respectively views of a damper device according to a second embodiment of the present invention. In the damper device shown in these figures, the portions thereof, which are the same as or are equivalent to the portions of the damper device according to the previously described first embodiment, are given the same designations and thus the detailed description thereof is omitted here.

The damper device according to the present embodiment, as shown in FIG. 11, includes a cylindrical-shaped cylinder 10, a piston 20 movable through the cylinder 10 while keeping a sealed state between the cylinder 10 and itself, a cap 50 to be mounted onto one end of the cylinder 10, and a piston rod 30 which is formed integrally with the piston 20 and can be moved out of and into the cap 50.

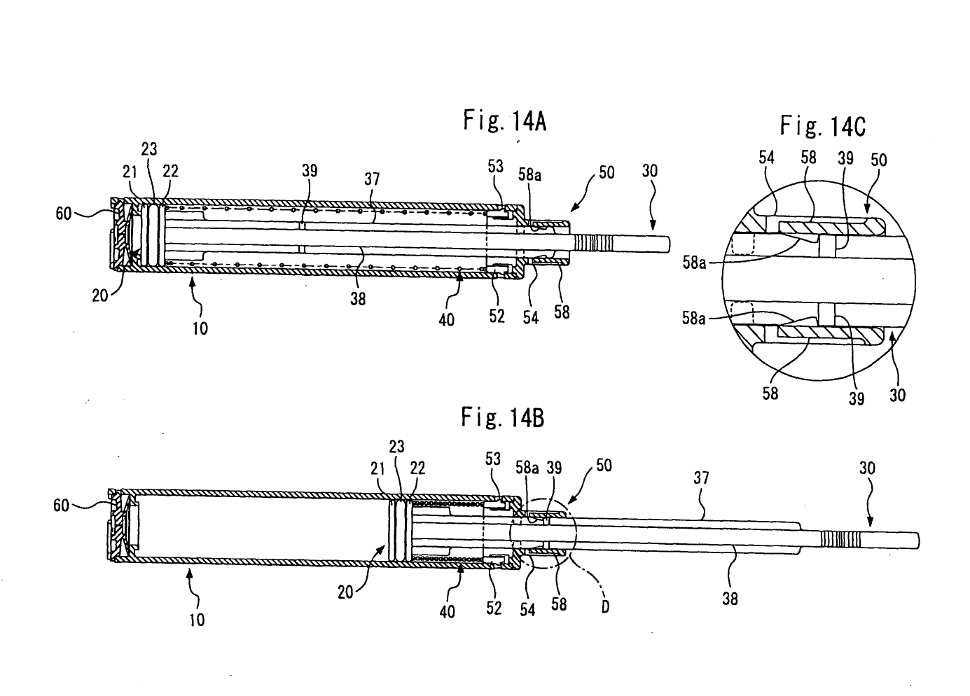

On the leading end of the cylinder 10, there is mounted a leading end cap 60 which constitutes a valve mechanism. When the piston rod 30 is moved from the trailing end of the cylinder 10 in a pull-out direction (in FIG. 14A, in the right direction), the air existing on the outside is allowed to flow little by little into the cylinder 10 from an orifice formed in the leading end cap 60 to thereby generate a negative pressure, so that a damping force is applied onto the piston rod 30. On the other hand, when the piston rod 30 is moved in a direction (in FIG. 14B, in the left direction) where the piston rod 30 is pushed into the cylinder 10, the valve mechanism formed by the leading end cap 60 is opened to discharge the air within the cylinder 10 to the outside with no resistance, so that no damping force can be applied onto the piston rod 30.

To assemble the damper device, the spring 40 may be fitted with the outer surface of the outer periphery of the piston rod 30 and, after then, with the piston 20 as the leading end of the piston rod 30, the piston rod 30 may be inserted from the trailing end opening of the cylinder 10 into the hollow portion thereof. And, while pushing the spring 40 into the hollow portion of the cylinder 10, the cap 50 may be mounted onto the trailing end opening of the cylinder 10.

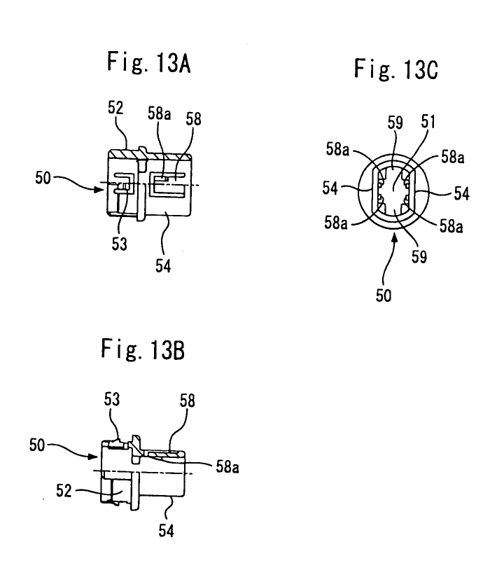

On the cap 50, there is formed an engaging wall (a wall portion) 54 which expands from the outer end face thereof to the outside of the cylinder 10 along the axial direction of the cap 50. In the trailing end portion of the engaging wall 54, there is formed an insertion hole 51 (see FIG. 13C) for the piston rod 30, while the trailing end side of the piston rod 30 can be exposed from this insertion hole 51 to the outside.

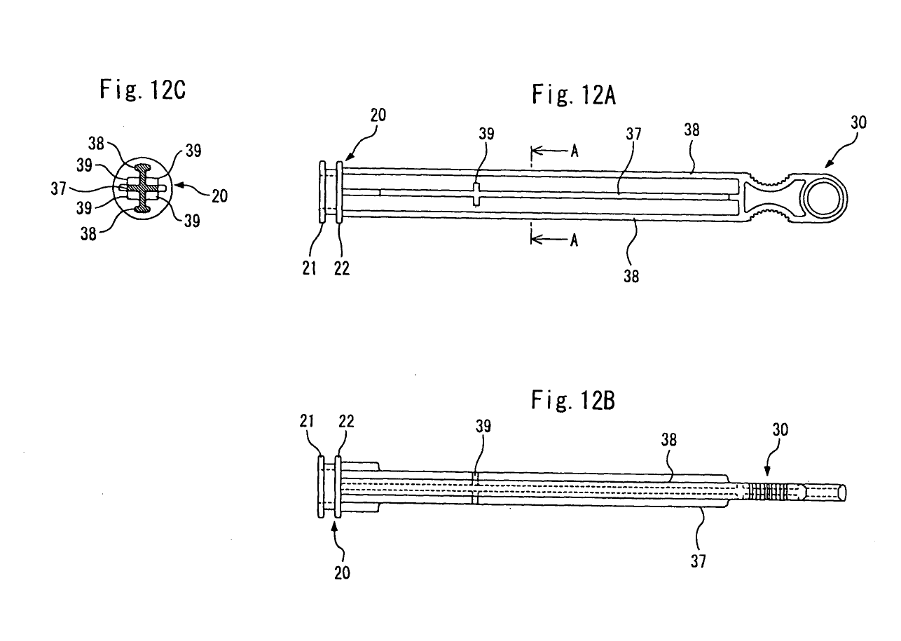

The piston rod 30, as shown in FIGS. 12A to 12C, is made of a plate-shaped member which extends from the trailing end face of the piston 20, and includes ribs 37, 38 which are provided on the upper and lower peripheral edges and side surface central portions thereof in such a manner that they respectively extend in the axial direction thereof. Also, the piston rod 30 further includes a projecting secured portion 39 which serves as a secured portion. This projecting secured portion 39 is composed of a pair of projecting secured portions which are respectively formed on both symmetric side surfaces of the piston rod 30 (see FIG. 12C).

On the other hand, the engaging wall 54 of the cap 50, as shown in FIGS. 13A to 13C, includes a securing portion which is used to secure the projecting secured portion 39. This securing portion includes an elastic support piece 58 cut out from the engaging wall 54 and a securing pawl 58a which projects from the inner surface of the support piece 58 and faces the piston rod 30.

The piston rod 30 can be moved in the axial direction thereof through the insertion hole 51 existing inside the engaging wall 54. When the piston rod 30 is pulled out in the pull-out direction (in FIG. 14A, in the right direction), the projecting secured portion 39 is secured by the securing pawl 58a formed inside the engaging wall 54.

Specifically, as the support piece 58, there are used a pair of support pieces 58 which are respectively formed on both side surfaces (at mutually opposing positions) of the engaging wall 54; and further, as the securing pawl 58a, there are used a pair of support pieces 58a which are respectively formed by cutting out the central portions of the inner surfaces of the respective support pieces 58 (see FIG. 13C). To the thus cut-out portions of the support pieces 58, there is opposed the rib 37 that is provided on the side surface central portion of the piston rod 30 in a state where the piston rod 30 is inserted. Also, the securing pawls 58a, which are provided in four portions, are structured such that they can secure thereto the projecting secured portions 39 which are similarly disposed opposed to these securing pawls 58a (see FIGS. 14B and 14C).

Also, the engaging wall 54 includes a guide groove 59 which is used to slide and guide the piston rod 30 in the axial direction, while the inside surface of the guide groove 59 forms a rotation preventer for preventing the piston rod from rotating about the center axis thereof (see FIG. 13C)

In the above-structured damper device according to the present embodiment, when the piston rod 30 is pulled out from the cylinder 10 and the projecting secured portions 39 move over their associated securing pawls 58a respectively, the projecting secured portions 39 and their associated securing pawls 58a are engaged with each other. Owing to the engagement between the projecting secured portions 39 and their associated securing pawls 58a, as shown in FIGS. 14B and 14C, in the pulled-out position, the piston rod 30 can be held against the energizing force that is applied from the spring 40.

In the damper device according to the present embodiment as well, similarly to the first embodiment, when connecting the piston rod 30 to the openable/closable box 102 of the vehicle, by previously holding the piston rod 30 at the pulled-out position against the energizing force of the spring 40, this connecting operation can be carried out easily (see FIG. 8).

After the trailing end portion of the piston rod 30 is connected to the openable/closable box 102, when the openable/closable box 102 is closed, the piston rod 30 of the damper device is pushed into the cylinder (see FIG. 9) and, at the then time, the projecting secured portions 39 are respectively released from their associated securing pawls 58a.

According to the structure of the present embodiment, since the securing pawls 58a are provided on the engaging wall 54 which expands outwardly of the cylinder 10, even when these securing pawls 58a and/or the projecting secured portions 39 secured by the securing pawls 58a are damaged or broken into fragments, the fragments can be prevented from entering the inside of the cylinder 10.

### Third Embodiment

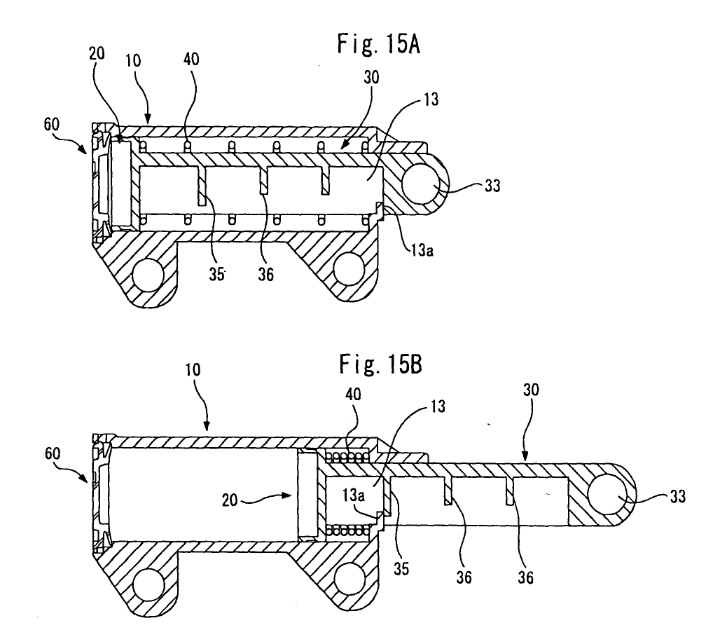

Now, FIGS. 15A and 15B are respectively front section views of a damper device according to a third embodiment of the present invention. Here, in the damper device shown in these figures, the portions thereof, which are the same as or are equivalent to the portions of the damper devices according to the first and second embodiments, are given the same designations and thus the detailed description thereof is omitted here.

The damper device according to the present embodiment, similarly to the second embodiment, includes a cylindrical-shaped cylinder 10, a piston 20 movable through the cylinder 10 while keeping a sealed state between the cylinder 10 and itself, and a piston rod 30 which is formed continuously with the piston 20 and can be moved out of and into one end of the cylinder 10.

In the trailing end portion of the cylinder 10, there is formed an insertion hole 13 through which the piston rod 30 can be inserted. The piston rod 30 is structured such that the end portion side thereof can be exposed through this insertion hole 13 to the outside of the cylinder 10.

Also, the internal portion of the piston rod 30 is formed as a hollow portion and, in the internal hollow portion, there are provided a plurality of reinforcing ribs 35, 36 such that they are arranged side by side in the axial direction of the piston rod 30. One side surface of the outer wall of the piston rod 30 is cut out, while the opening edge portion 13a of the insertion hole 13 formed in the cylinder 10 extends into the inside of the piston rod 30 from the thus cut-out surface. And, of the reinforcing ribs 35, 36 provided in the internal portion of the piston rod 30, the reinforcing rib (a secured rib) 35 situated nearest to the piston 20 is extended longer than the remaining reinforcing ribs 36, and the secured rib 35 can be engaged with the opening edge portion 13a of the insertion hole 13 formed in the cylinder 10.

That is, according to the present embodiment, the secured rib 35 forms a secured portion, while the opening edge portion 13a of the insertion hole 13 formed in the cylinder 10 forms a securing portion. When the piston rod 30 is pulled out from the cylinder 10, the secured rib 35 moves over the opening edge portion 13a of the insertion hole 13 and is exposed to the outside of the cylinder 10, whereby the secured rib 35 is engaged with the opening edge portion 13a of the insertion hole 13 (see FIG. 15B). In this state, the piston rod 30 is held at a position where it is pulled out from the cylinder 10 against the energizing force of the spring 40.

Also, when the piston rod 30 is pushed into the cylinder 10 from this position, the secured rib 35 moves over the opening edge portion 13a of the insertion hole 13, thereby releasing the engaged state between them.

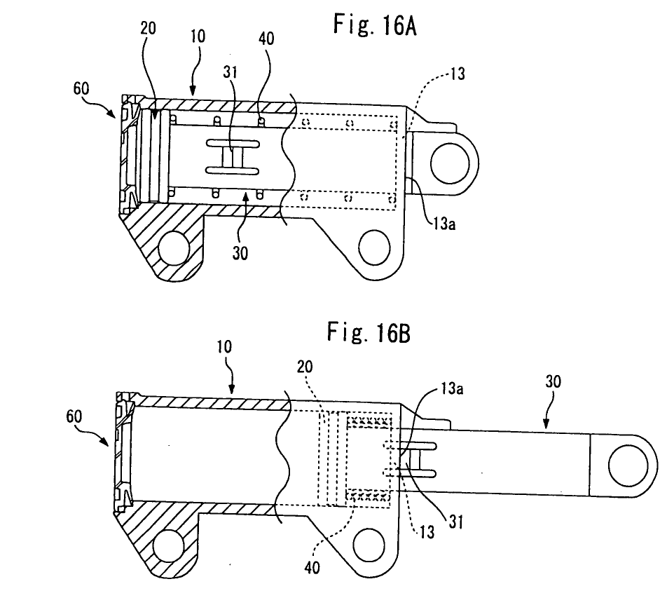

FIGS. 16A and 16B are respectively front section views of a modification of the above-mentioned damper device according to the third embodiment.

In the damper device according to the third embodiment shown in FIGS. 15A and 16B, one (the secured rib 35) of the reinforcing ribs provided on the piston rod 30 constitutes the secured portion. However, in the modification shown in FIGS. 16A and 16B, instead of the secured rib 35, a secured pawl 31, which is provided on the peripheral surface of the piston rod 30, is used to constitute a secured portion. The shape and forming position of the secured pawl 31 are the same as in the previously described first embodiment.

According to this structure as well, when the piston rod 30 is pulled out of the cylinder 10, the secured pawl 31 is moved over the opening edge portion 13a of the insertion hole 13 and is exposed to the outside of the cylinder 10, whereby the secured pawl 31 is engaged with the opening edge portion 13a of the insertion hole 13 (see FIG. 16B). In this state, the piston rod 30 is held at a position where it is pulled out from the cylinder 10 against the energizing force of the spring 40.

Also, when the piston rod 30 is pushed into the cylinder 10 from this position, the secured pawl 31 is moved over the opening edge portion 13a of the insertion hole 13, thereby releasing the engaged state between them.

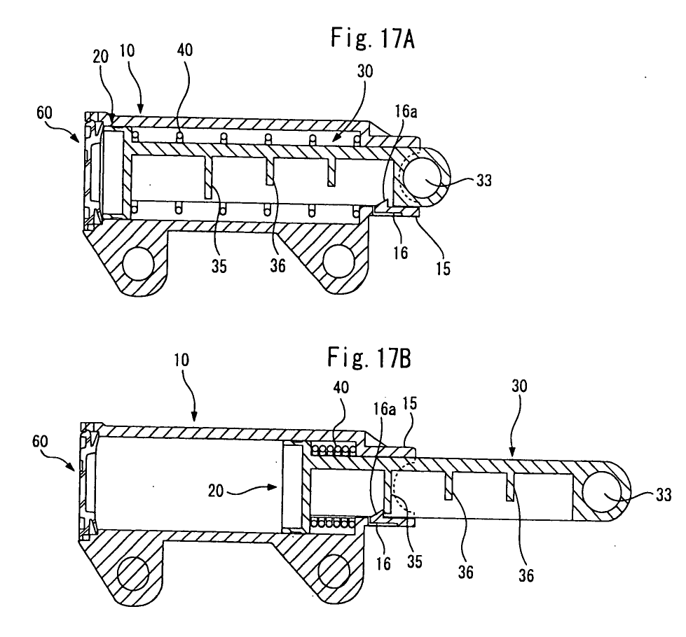

Now, FIGS. 17A and 17B are respectively front section views of another modification of the above-mentioned damper device according to the third embodiment.

According to the damper device shown in these figures, on the cylinder 10 used in the third embodiment, there is provided an engaging wall 15 (a wall portion) which expands outwardly from the outer end face of the cylinder 10 along the axial direction thereof. This engaging wall 15 is formed integrally with the cylinder 10. Therefore, when compared with the damper device according to the second embodiment, the damper device omits the cap 50 and thus it is characterized in that the number of parts is reduced.

The piston rod 30, similarly to the third embodiment, includes a plurality of reinforcing ribs 35, 36 which are provided in the internal space thereof and are arranged side by side in the axial direction of the piston rod 30; and, of these reinforcing ribs, a reinforcing rib 35 (which is hereinafter referred to as a secured rib) functions as a secured portion. This secured rib 35 is formed to extend longer than the other remaining reinforcing ribs 36.

On the other hand, on the engaging wall 15, specifically, on the lower surface side thereof, there is provided a securing portion which is used to secure the secured rib 35. This securing portion includes an elastic support piece 16 formed by cutting out a portion of the engaging wall 15, and a securing pawl 16a which is provided on and projected from the inner surface of the support piece 16 in such a manner that it is opposed to the piston rod 30.

According to the damper device, when the piston rod 30 is pulled out from the cylinder 10 and the secured rib 35 is moved over the securing pawl 16a, the secured rib 35 and the securing pawl 16a are engaged with each other. Owing to this, against the energizing force of the spring 40, the piston rod 30 can be held at a position where it is pulled out from the cylinder 10 (see FIG. 17B).

Also, when the piston rod 30 is pushed into the cylinder 10 from this position, the securing pawl 16a is spread open by the support piece 16 and thus the secured rib 35 is moved over the securing pawl 16a, thereby releasing the engaged state between them.

### Fourth Embodiment

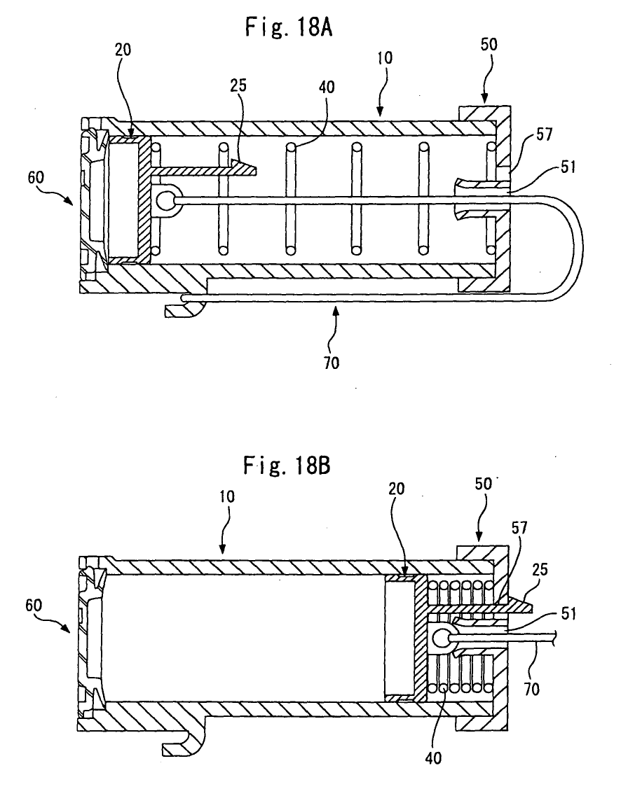

Now, FIGS. 18A and 18B are respectively front section views of a damper device according to a fourth embodiment of the present invention. Here, in the damper device shown in these figures, the portions thereof, which are the same as or are equivalent to the portions of the damper devices according to the previously described first to third embodiments, are given the same designations and thus the detailed description thereof is omitted here.

In the damper device according to the present embodiment, as the connecting member for the piston 20, there is used a string-shaped member 70 instead of the piston rod 30.

And, the damper device includes hold means which is used to hold the string-shaped member 70 at a moved position where the string-shaped member 70 has been pulled out from the cylinder 10. The hold means includes a secured pawl 25 (a secured portion) provided on and projected from the trailing end face of the piston 20, and an engaging hole 57 (a securing portion) opened up in the cap 50. Here, the cap 50 is fitted with and fixed to the trailing end portion of the cylinder 10.

According to the damper device of the present embodiment, when the string-shaped member 70 is pulled out from the cylinder 10, the secured pawl 25 is engaged with the engaging hole 57 and, against the energizing force of the spring 40, the string-shaped member 70 is held at the moved position where it has been pulled out from the cylinder 10 (see FIG. 18B). Here, the secured pawl 25 is exposed to the outside of the cap 50 through the engaging hole 57. Therefore, the engaged state between the secured pawl 25 and engaging hole 57 can be released simply by an operator pushing the exposed secured pawl 25 in the lateral direction thereof with his or her finger or the like.

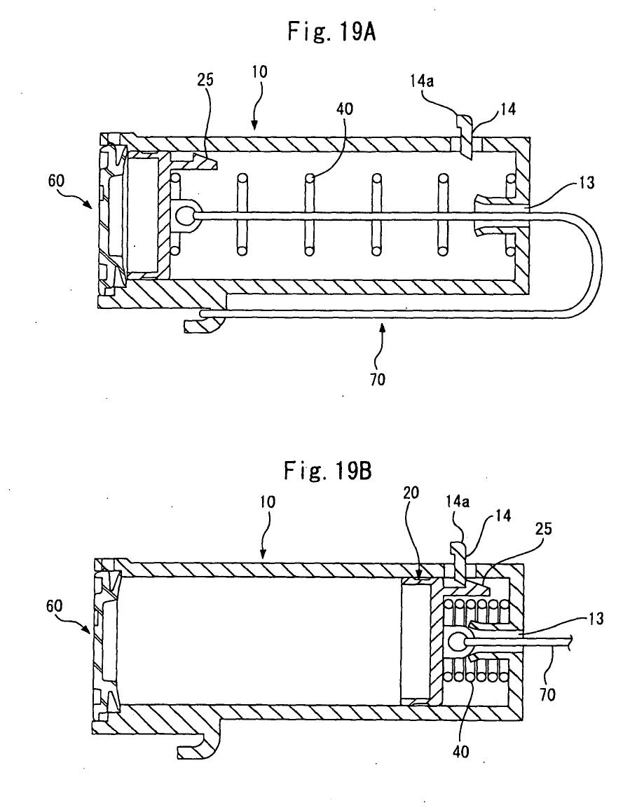

Now, FIGS. 19A and 19B are respectively front section views of a modification of the above-described damper device according to the fourth embodiment.

In the damper device according to the fourth embodiment shown in FIGS. 18A and 18B, the engaging hole 57 formed in the cap 50 is used to constitute the securing portion. However, in the modification shown in FIGS. 19A and 19B, a securing portion is constituted by an engaging piece 14 which is provided on and projected inwardly from the peripheral wall of the cylinder 10. The portion of the peripheral wall of the cylinder 10, which corresponds to the periphery of the engaging piece 14, is cut out; and, the thus cut-out portion is connected in part to the engaging piece 14. Further, the base portion 14a of the engaging piece 14 is projected externally from the peripheral wall of the cylinder 10. When the base portion 14a is pushed in such a manner that it is pushed down forwardly, the engaging piece 14 is flexed elastically to thereby release the engaged state of the securing piece 14 with the secured pawl 25. That is, the base portion 14a of the engaging piece 14 constitutes a releasing portion for releasing the engaged state of the secured pawl 25.

According to this structure as well, when the secured pawl 25 is engaged with the engaging piece 14, against the energizing force of the spring 40, the string-shaped member 70 can be held at the position where it has been pulled out from the cylinder 10 (see FIG. 19B). Also, the engaged state between the secured pawl 25 and engaging piece 14 can be released by pushing the base portion 14a of the engaging piece 14 in such a manner that it is pushed down forwardly of the cylinder 10 to thereby flex the engaging piece 14 elastically.

Here, the present invention is not limited to the embodiments of the present invention that have been described heretofore.

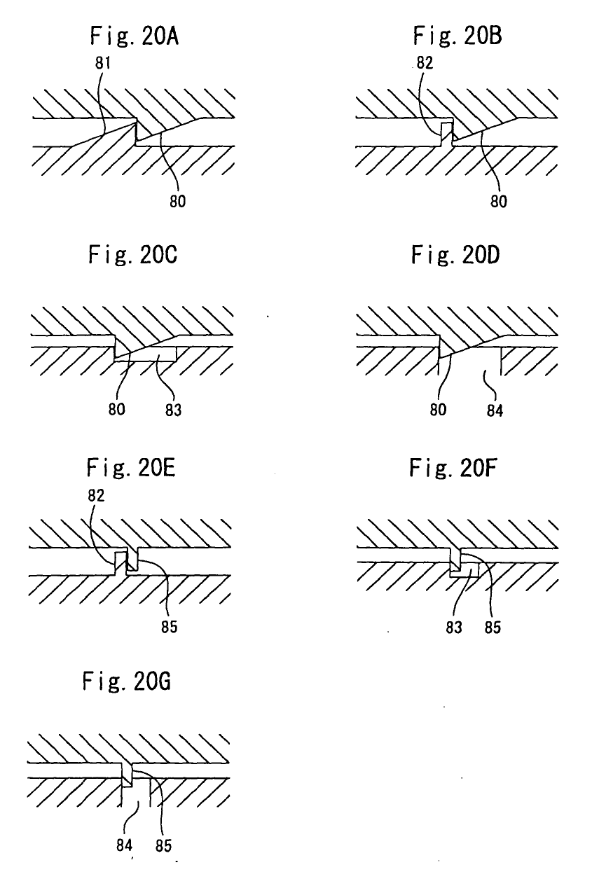

For example, the hold means, which is used to hold the piston connecting member at the moved position where it has been pulled out from the cylinder, may choose any one of such combination structures of a securing portion and a secured portion as shown in FIGS. 20A to 20G respectively.

That is, the securing portion and the secured portion may have any one of combination structures including a combination structure of a pawl 80 and a pawl (FIG. 20A), a combination structure of a pawl 80 and a projecting portion (FIG. 20B), a combination structure of a pawl 80 and a recessed portion 83 (FIG. 20C), a combination structure of a pawl 80 and a hole 84 (FIG. 20D), a combination structure of a projecting portion 85 and a projecting portion 83 (FIG. 20E), a combination structure of a projecting portion 85 and a recessed portion 83 (FIG. 20F), and a combination structure of a projecting portion 85 and a hole 84 (FIG. 20G). In this case, either of the composing elements to be combined may be used as the securing portion or as the secured portion.

1. A damper device, comprising:
a cylindrical-shaped cylinder;
a piston reciprocatingly movable within the cylinder in the axial direction thereof;
a piston connecting member having one end connected to the piston, at least the other end of the connecting member being exposed to the outside from the end face of the cylinder, and the piston connecting member being reciprocatingly movable together with the piston; and
a spring for energizing the piston connecting member in a direction where it is pushed into the inside of the cylinder,
wherein the damper device further includes hold means which, against the energizing force of the spring, can hold the piston connecting member at a moved position where it has been pulled out from the cylinder.

2. A damper device according to claim 1, wherein the hold means is composed of a securing portion and a secured portion which is to be secured to the securing portion, and
wherein one of the securing portion and the secured portion is composed of a pawl or a projecting portion, and the other is composed of any one of a pawl, a projecting portion, a recessed portion and a hole to be secured to the pawl or the projecting portion.

3. A damper device according to claim 1, wherein the cylinder is mounted on a main body of a storage device including an openable/closable member, and the piston connecting member is connected to the openable/closable member, and
wherein the hold means is structured such that it can hold the piston connecting member at a position where the piston connecting member has been pulled out beyond the range of such movement of the piston connecting member as caused by the opening and closing operation of the openable/closable member.

4. A damper device according to claim 1, wherein the piston connecting member is composed of a rod-shaped piston rod, a cap is provided on the end portion of the cylinder and, in the cap, there is formed an opening through which the piston rod can be inserted, and
wherein the hold means is composed of a securing portion formed in the cap and a secured portion which is formed in the piston rod and can be secured to the securing portion.

5. A damper device according to claim 4, wherein the secured portion includes a pair of secured portions respectively formed on the two symmetric side surfaces of the piston rod, and
wherein the securing portion is structured such that it can secure the pair of secured portions respectively at the opposing positions of the cap.

6. A damper device according to claim 4, wherein, on the piston rod, there is provided a pawl or a projecting portion serving as the secured portion, and
wherein, on the cap, there is provided a wall portion expanding from the inside end face of the cap into the inside of the cylinder, and, in the wall portion, there is formed an engaging hole serving as the securing portion.

7. A damper device according to claim 6, wherein the pawl or projecting portion serving as the secured portion can be engaged with the engaging hole serving as the securing portion from the inside of the wall portion and can be exposed to the outside of the engaging hole;
wherein a reinforcing rib is provided on and projected from the outer surface of the wall portion in such a manner that it extends through the edge portion of the engaging hole up to the inside end face of the cap, and the spring is disposed on the outer periphery of the reinforcing rib.

8. A damper device according to claim 4, wherein, on the piston rod, there is provided a pawl or a projecting portion serving as the secured portion; and
wherein, on the cap, there is provided a wall portion expanding in the axial direction from the outside end face of the cap to the outside of the cylinder, and in the wall portion, there is formed any one of a pawl, a projecting portion, recessed portion and a hole serving as the securing portion.

9. A damper device according to claim 8, wherein the securing portion includes an elastic support piece cut out from the wall portion and a securing pawl provided on and projected from the inner surface of the support piece in such a manner that it is opposed to the piston rod.

10. A damper device according to claim 9, wherein the axial-direction end portion of the support piece near to the cylinder is formed as a free end cut out from the wall portion, whereas the opposite side axial-direction end portion thereof is formed as a fixed end continuous with the wall portion.

11. A damper device according to claim 8, wherein, in the wall portion, there is formed a guide groove for sliding and guiding the piston rod in the axial direction thereof, and the inside surface of the guide groove is formed as a rotation preventer for preventing the piston rod from rotating about the center axis thereof.

12. A damper device according to claim 1, wherein the piston connecting member is composed of a rod-shaped piston rod, and
wherein the hold means includes a securing portion provided on the cylinder and a secured portion which is formed in the piston rod and can be secured to the securing portion.

13. A damper device according to claim 12, wherein, in the end portion of the cylinder, there is formed an opening through which the piston rod can be inserted,
wherein the secured portion is composed of a pawl or a projecting portion provided on the piston rod, and
wherein the edge portion of the opening of the cylinder constitutes the securing portion.

14. A damper device according to claim 12, wherein, on the piston rod, there is provided a pawl or a projecting portion serving as the secured portion,
wherein, on the cylinder, there is provided a wall portion expanding in the axial direction of the cylinder from the outside end face of the cylinder to the outside thereof, and, in the wall portion, there is formed any one of a pawl, a projecting portion, a recessed portion and a hole serving as the securing portion.

15. A damper device according to claim 14, wherein the securing portion includes an elastic support piece cut out from the wall portion and a securing pawl provided on and projected from the inner surface of the support piece in such a manner that it is opposed to the piston rod.

16. A damper device according to claim 15, wherein the axial-direction end portion of the support piece near to the cylinder is formed as a free end cutout from the wall portion, whereas the opposite side axial-direction end portion thereof is formed as a fixed end continuous with the wall portion.

17. A damper device according to claim 14, wherein, in the wall portion, there is formed a guide groove for sliding and guiding the piston rod in the axial direction thereof, and the inside surface of the guide groove is formed as a rotation preventer for preventing the piston rod from rotating about the center axis thereof.

18. A damper device according to claim 1, further including a cap provided on the end portion of the cylinder and an opening formed in the cap for allowing the insertion of the piston connecting member therethrough,
wherein the hold means includes a securing portion formed in the cap and a secured portion which is formed in the piston and can be secured to the securing portion.

19. A damper device according to claim 1, wherein the hold means includes a securing portion formed in the cylinder and a secured portion which is formed in the piston and can be secured to the securing portion.

20. A damper device according to claim 19, wherein the piston connecting member is made of a string-shaped member,
wherein the securing portion is made of an engaging piece, the secured portion is made of a secured pawl which can be engaged with the engaging piece, and
further wherein, in the securing portion, there is formed a releasing portion for releasing the engaged state of the secured pawl.
